(19) United States
(12) Patent Application Publication
(10) Pub. No.: US 2023/0119914 A1
(43) Pub. Date: Apr. 20, 2023

(54) ECO-FRIENDLY VEHICLE AND METHOD OF VALET MODE CONTROL FOR THE SAME

(71) Applicants: HYUNDAI MOTOR COMPANY, SEOUL (KR); KIA CORPORATION, SEOUL (KR)

(72) Inventors: GYU RI LEE, Namyangju-si (KR); Seong Wook MOON, Seoul (KR); Do Hwa KIM, Seoul (KR); Sung Bae JEON, Ansan-si (KR); Sung Il JUNH, Busan (KR); Jae Young PARK, Seongnam-si (KR); Jeong Eun KIM, Seoul (KR); Hui Un SON, Suwon-si (KR)

(21) Appl. No.: 17/848,106

(22) Filed: Jun. 23, 2022

(30) Foreign Application Priority Data
Oct. 18, 2021 (KR) 10-2021-0138331

(51) Int. Cl. B60W 30/06; B60W 20/13; B60W 40/06; B60W 10/06

(52) U.S. Cl. CPC B60W 30/06; B60W 20/13; B60W 40/06; B60W 10/06; B60W 2510/244; B60W 2510/068; B60W 2552/25; B60W 2710/0677; B60W 2720/103

(57) ABSTRACT

The present disclosure relates to an eco-friendly vehicle in which valet mode can be controlled with detailed control levels, and a method for controlling the same mode. A method for controlling valet mode of a vehicle according to an embodiment of the present disclosure comprises determining whether an entry condition for the valet mode to be satisfied, determining, if the condition being satisfied, one level among a plurality of levels for the valet mode based on at least one of a vehicle state and a driving environment and performing a vehicle control according to the determined level, wherein the plurality of levels are different from one another in whether or not a restriction to be made to at least part of a powertrain and a function or a degree of the restriction.

### CROSS-REFERENCE TO RELATED APPLICATION

This application claims the benefit of Korean Patent Application No. 10-2021-0138331, filed on Oct. 18, 2021, which is hereby incorporated by reference as if fully set forth herein.

### BACKGROUND

### Field

The present disclosure relates to an eco-friendly vehicle in which valet mode can be controlled with detailed control levels, and a method for controlling the same mode.

### Discussion of the Related Art

“Valet Mode” means a mode in which an owner of a vehicle can restrict part of functions thereof before handing over where he or she allows for other person to drive the vehicle temporally for a reason such as using a valet parking service.

A conventional valet mode may inform the owner of the driving distance up until the engine is turned off, the duration time, the highest speed, and the like through a smart phone application or a display of the vehicle upon the owner terminating the mode therein. Also, in the mode, besides the function of informing, it is possible to restrict a function of the AVN (Audio/Video/Navigation) system (i.e., restriction of browsing destinations in the navigation history, restriction of access to the driver's profile, restriction of connection through the wireless communication, etc.) to protect the driver's privacy. Also, upon the activation of the valet mode, an access to a specific space such as the trunk or the glove box may be restricted such as by locking, and an output power or rpm of the engine may be—depending on a vehicle—restricted.

However, the conventional valet mode is only provided with on/off control, so that a detailed control is not possible, and also the characteristics of eco-friendly vehicles such as an EV (Electric Vehicle) or a HEV (Hybrid Electric Vehicle), recently popularized, are not considered. For example, it is general that, in the valet mode, a vehicle is controlled to be driven for a short distance at a low velocity since the valet mode is generally activated at a parking lot, however, by some conditions (e.g., engine catalyst heating, air conditioning, etc.) other than a request for high power, the engine may be unnecessarily started and it is not considered (in the conventional valet mode).

### SUMMARY

An object of the present disclosure is to provide an eco-friendly vehicle in which valet mode can be provided with characteristics of eco-friendly vehicles and a method for controlling the same mode.

Additional objects of the disclosure will be set forth in part in the description which follows and in part will become apparent to those having ordinary skill in the art upon examination of the following or may be learned from practice of the disclosure. The objects of the disclosure may be realized and attained by the structure particularly pointed out in the written description and claims hereof as well as the appended drawings.

To achieve the above goals, a method for controlling valet mode of a vehicle according to an embodiment of the present disclosure comprises determining whether an entry condition for the valet mode is satisfied, determining, if the condition is satisfied, one level among a plurality of levels for the valet mode based on at least one of a vehicle state and a driving environment, and performing a vehicle control according to the determined level, wherein the plurality of levels are different from one another in whether or not a restriction to be made to at least part of a powertrain and a function or a degree of the restriction.

For example, the determination of one level is made by determining entry conditions of the respective levels sequentially from a lowest level.

For example, wherein entry conditions of the respective levels are made up such that entry conditions of each level include at least a part of entry conditions of a lower level.

For example, wherein, in an embodiment in which the vehicle is an eco-friendly vehicle having an electric motor, entry conditions of the respective levels are made up such that the higher the level is, the higher a condition for SOC of a battery is.

For example, wherein, in an embodiment in which the vehicle further comprises an engine, the performing of the vehicle control comprises raising a threshold power for turning the engine on at an upper level.

For example, wherein the performing of the vehicle control is conducted such that a start of the engine according to at least one of a requested power, a request of FATC, a request of catalyst heating, a request of warm-up is prevented.

For example, wherein the performing of the vehicle control is conducted such that the higher the determined level is the lower a speed limit or an acceleration limit is automatically set.

For example, wherein a restricting range for the acceleration limit is set with a slope degree taken into consideration with reference to a maximum acceleration by speed able to be achieved by the vehicle on a flat road.

For example, wherein the entry conditions of the respective levels comprise at least one of a road type, a speed limit, whether or not to be an emergency, an SOC of a battery, a travelled time and a travelled distance after an entry of the valet mode, and whether or not a specific function to be activated on.

A computer-readable storage medium according to an embodiment of the present disclosure stores a program for implementing the methods described above.

Also, an apparatus of controlling valet mode of a vehicle according to an embodiment of the present disclosure comprises an entry determining unit configured to determine whether an entry condition for the valet mode to be satisfied, a level determining unit configured to determine, in case of the condition being satisfied, one level among a plurality of levels for the valet mode based on at least one of a vehicle state and a driving environment, and a control unit configured to perform a vehicle control according to the determined level, wherein the plurality of levels are different from one another in whether or not a restriction to be made to at least part of a powertrain and a function or a degree of the restriction.

For example, wherein the level determining unit determines entry conditions of the respective levels sequentially from a lowest level.

For example, wherein entry conditions of the respective levels are made up such that entry conditions of each level include at least a part of entry conditions of a lower level.

For example, wherein, where the vehicle is an eco-friendly vehicle having an electric motor, entry conditions of the respective levels are made up such that the higher the level is, the higher a condition for SOC of a battery is.

For example, wherein, where the vehicle further comprises an engine, the control unit raises a threshold power for turning the engine on at an upper level.

For example, wherein the control unit prevents the engine from being started according to at least one of a requested power, a request of FATC, a request of catalyst heating, a request of warm-up.

For example, wherein the higher the determined level is, the more the control unit reduces a speed limit or an acceleration limit.

For example, wherein a restricting range for the acceleration limit is set with a slope degree taken into consideration with reference to a maximum acceleration by speed able to be achieved by the vehicle on a flat road.

For example, wherein the entry conditions of the respective levels comprise at least one of a road type, a speed limit, whether or not to be an emergency, a SOC of a battery, a travelled time and a travelled distance after an entry of the valet mode, and whether or not a specific function to be activated on.

According to various embodiments of the present disclosure as described above, since valet mode is provided with characteristics of and driving environment surrounding eco-friendly vehicles taken into consideration, more convenience is obtained.

Additional advantages and features of the disclosure will be set forth in part in the description which follows and in part will become apparent to those having ordinary skill in the art upon examination of the following or may be learned from practice of the disclosure. Other advantages of the disclosure may be realized and attained by the structure particularly pointed out in the written description and claims hereof as well as the appended drawings.

### BRIEF DESCRIPTION OF THE DRAWINGS

FIG. 1 is a conceptual block diagram of components of an example of a control unit according to an embodiment of the present disclosure.

FIG. 2 is an example of an indicator for a battery charge state according to an embodiment of the present disclosure.

FIG. 3 is an example APS scaled according to an embodiment of the present disclosure.

FIG. 4 is an example of torque command being adjusted in accordance with a driver requested torque according to an embodiment of the present disclosure.

FIG. 5 is an example of a level being set by function according to an embodiment of the present disclosure.

FIG. 6 is a flowchart of an example of a procedure of a valet mode control according to an embodiment of the present disclosure.

### DETAILED DESCRIPTION

Hereinafter, embodiments of the present disclosure will be described in detail with reference to the accompanying drawings, and the same or similar elements will be given the same reference numerals regardless of reference symbols, and redundant description thereof will be omitted. In the following description, the terms “module” and “unit” for referring to elements are assigned and used interchangeably in consideration of convenience of explanation, and thus, the terms per se do not necessarily have different meanings or functions. Further, in describing the embodiments disclosed in the present specification, when it is determined that a detailed description of related publicly known technology may obscure the gist of the embodiments disclosed in the present specification, the detailed description thereof will be omitted. The accompanying drawings are used to help easily explain various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although terms including ordinal numbers, such as “first”, “second”, etc., may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

In addition, the term “unit” or “control unit” included in the names of a hybrid control unit (HCU), a motor control unit (MCU), etc. is merely a widely used term for naming a controller that controls a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

In embodiments of the present disclosure, it is suggested in an eco-friendly vehicle providing valet mode that the mode is controlled at plural levels with not only driving environment until the vehicle being parked but also characteristics of eco-friendly vehicles taken into consideration. “Valet mode” in the below description may mean a mode in which an owner or a fully-authorized driver of the vehicle or a driver driving the vehicle up to a location at which expected to be replaced can change at least a part of settings of the vehicle or restrict at least a part of functions/performance. Also, “have/has plural levels” may mean that there are upper-and-lower relationships among the levels and a specific level may have at least one of an upper and a lower levels.

In addition, execution/change/restriction of a function of a vehicle according to plural levels may include at least one of 1) engine start line (i.e., threshold) which is a condition of starting an engine in a hybrid power-train, 2) control of performance of FATC, 3) speed limit, 4) acceleration limit, 5) reduction of impact in parking, 6) driver-estimation function, 7) function of feedback of parking location, 8) drive-mode (eco, normal, sports, etc.) restriction function, 9) safety function. These are listed as below in the TABLE 1.

TABLE l

| | | Main |
|---|---|---|
| What to | | Control |
| Control | How to Control | Unit |
| Engine | Raising a threshold of a requested power | HCU |
| | for starting the engine | |
| | Preventing the engine from being started | |
| | according to a request of FATC/catalyst- | |
| | heating/warm-up | |
| FATC | Restricting or inhibiting the power | HCU |
| Speed Limit | Automatically activating Manual Speed | HCU |
| | Limit Assist (MSLA) | |
| | Using Intelligent Speed Limit Assist | |
| | (ISLA) or differentiating speed limits | |
| | according to the types of roads | |
| Acceleration | Adjusting APS scaling/enhancing | HCU |
| Limit | filtering for requested torque | |
| | Automatically activating Manual | |
| | Acceleration Limit Assist | |
| Impact in | Reducing an amount of impact due to a | HCU |
| Parking | parking bump by lowering creep torque or | |
| | accelerating torque in parking | |
| | Activation in the R-gear or in activating | |
| | Parking Assist System (PAS) | |
| Drive | Exposing a vehicle drive estimation | AVN/HCU |
| Estimation | function (e.g., materialized in a form like | |
| | ‘ECO’ level) | |
| | Calculating scores by quantifying rapid- | |
| | acceleration/sudden-braking/parking- | |
| | location/impact-in-parking | |
| Parking | Moving the vehicle when parking at “No | CLU/ |
| Location | Parking” area, high degree slope, strong | HCU, SCU |
| | sunlight area | |
| | Performing parking-requested-output/ | |
| | parking-inhibition-control | |
| Mode | Preventing Sports mode from being used | CLU |
| Restriction | Forcing Eco mode to be used | |
| Safety | Automatically activating Emergency- | CLU |
| Function | Braking-system/Blind-Spot-Detection(BSD)/ | |
| | Lane-Departure-Warning | |
| | Raising the volume level of warning sound | |

In the TABLE 1, the term “HCU” means Hybrid Control Unit, “AVN” Audio/Video/Navigation system, “CLU” Cluster Control Unit, and “SCU” SBW Control Unit. The objects for controls, the types of controls, and the main control units in TABLE 1 are only examples and the present disclosure is not limited thereto.

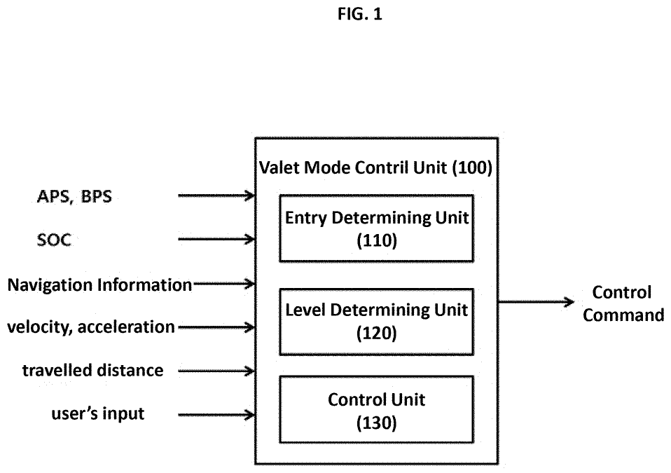

First, in reference to FIG. 1, a control unit for controlling valet mode according to an embodiment of the present disclosure will be described.

FIG. 1 is a conceptual block diagram of components of an example of a control unit according to an embodiment of the present disclosure.

In reference to FIG. 1, a valet-mode control unit 100 for controlling valet mode function may have an APS (Accelerator Pedal Position Sensor) value, a BPS (Brake Pedal Position Sensor) value, SOC (State of Charge) information of a battery, navigation information, speed/acceleration information, traveled distance (Odo), a user input command, etc. as input information. Also, a control command may be transmitted to another control unit related to the valet mode function as output information.

The APS and BPS values can be obtained from each sensor sensing a depressed amount of the corresponding pedal, and may be transformed to a requested power and a requested torque, respectively, transmitted from an upper-tier control unit (e.g., Hybrid Control Unit) for controlling a powertrain.

The SOC means a charge state of a high-voltage battery for supplying electric power to an electric motor (not shown) outputting a driving force, and can be obtained from a battery sensor or a battery control unit {e.g., BMS (Battery Management System)}.

The navigation information can be obtained from an AVN system, and may include, without being limited thereto, information on a current location or a classification of a road in front within a predetermined distance, a speed limit, whether to be a parking lot, etc.

The velocity information can be obtained from a vehicle speed sensor, and the acceleration information from an acceleration sensor, though these are only examples and the present disclosure is not necessarily limited thereto. For example, the acceleration information may be obtained by dividing a velocity by time.

The travelled distance can be obtained from a cluster.

The user input can be input through mechanisms for inputting commands equipped in the vehicle, e.g., a dial, key-buttons, a touch screen, etc., and may be, transmitted through manipulation of an application installed in a user's mobile terminal via a telematics center.

The above description as to where each input information to be obtained is only for the original source, the information may be transmitted to the valet-mode control unit 100 via other control units according to how to compose the vehicle or has been pre-processed such as filtering through other control units.

On the other hand, the valet-mode control unit 100 may comprise an entry determining unit 110, a level determining unit 120 and a control unit 130.

Since the valet-mode control unit 100 applicable to various embodiments may, according to a level, accompany control of the powertrain, it may be materialized, without being limited thereto, as a upper-tier control unit, such as a Vehicle Control Unit (VCU) in an EV or a Hybrid Control Unit (HCU) in an HEV, with integrated control function including control for the powertrain.

In the below description, the composing elements of the valet-mode control unit 100 are detailed.

At first, the entry determining unit 110 may determine whether at least one of predetermined conditions for entering valet mode is satisfied, and, if so, to activate the valet mode function. The predetermined conditions are, without being limited thereto, as follows:

A command for entering the valet mode is manually input by an owner through an AVN system or a User Setting Menu (USM).

A command for entering the valet mode is input by a remote control through a wireless communication network (e.g., a transmission of the command via a telematics system, an input of the command from a user's mobile terminal connected to a near-field communication network such as Wi-Fi or Bluetooth, etc.).

A change of the driver's weight is sensed by a seat sensor after the door's open-and-close sensed by a door sensor (i.e., a change of the driver).

Arrival to a predetermined location is sensed through the Navigation system (e.g., airport, hotel, restaurant, parking lot, locations which are determined to be valet-parking available areas or set by a driver in the Navigation system, etc.).

The vehicle arrives at a specific location determined by a Navigation system's machine learning or based on a Big Data processing associated with a telematics center (e.g., the Big Data being for drivers' past settings).

A registered device is changed not to be connected through Bluetooth.

The Parking Assist System is operated {the Parking Assist System may comprise, without being limited thereto, Smart Parking Assist System (SPAS), Remote Parking Assist System (RSPA), etc.}.

It is determined through a logic based on sensed information that it is a Parking-lot mode (e.g., analysis of manipulations of APS, BPS, etc.).

Next, the level determining unit 120 may determine based on a vehicle state and a driving situation at least one of a plurality of levels for the valet mode, which corresponds to a current situation where the entry determining unit 110 determines to activate the valet mode function.

For example, the levels for the valet mode may comprise 4-stepped levels according to an embodiment, and a condition for each level is as follows except for the case where a driver manually input.

The level determining unit 120 may set the lowest level 1 as a default setting in case where the entry determining unit 110 determines activation of the valet mode function.

The level determining unit 120 may determine a level 2 is reached where the level 1 condition is satisfied and one of the following conditions for the level 2 or two or more according to a setting is satisfied:

The current road is the national-highway/expressway or the like with a corresponding speed limit (e.g., 80 kph).

The speed limit of a road is equal to or over a predetermined value (e.g., 80 kph).

It is not a non-emergency situation (emergency situation may be, without being limited thereto, the case where siren-sound is sensed from around through a microphone equipped in the vehicle, the case where a SOS function of telematics service is activated on, the case where information on an adjacent car accident is received to the Navigation system through real-time traffic information, the case where an impact of the vehicle sensed by an acceleration sensor is over a predetermined value).

The driver who is set by an owner through the AVN system or USM is a “guest.”

SOC is below or equal to a predetermined threshold value.

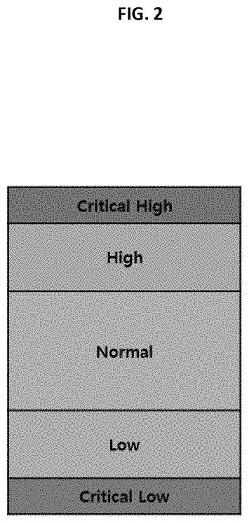

Among the level 2 conditions, the SOC condition is detailed in reference to FIG. 2.

FIG. 2 is an example of an indicator for a battery charge state. In reference to FIG. 2, SOC of a battery may be divided into a plurality of steps according to a range of the SOC, like Critical High, High, Normal, Low, and Critical Low, and Low or Critical Low may be set as a level 2 condition. The reason why the lower SOC range is selected is because a powertrain performance may be partly restricted at the level 2 compared to the level 1. Of course, the SOC range set as the level 2 condition is an example, without being limited thereto.

The level determining unit 120 may determine a level 3 is reached where the level 2 conditions are satisfied fully or partly except for a predetermined condition, and one of the following level 3 conditions or two or more according to a setting is satisfied [the excluded ones of the level 2 conditions may be a road type condition(s) (e.g., national highway or expressway)]:

The current road is a general or city road or the like with a corresponding speed limit (e.g., 50 kph).

The speed limit of a road is over and equal to a predetermined value (e.g., 40 kph), preferably the predetermined value being below or equal to the speed limit of the level 2 condition.

SOC is over or equal to a predetermined value, preferably the predetermined value being over or equal to the SOC of the level 2 condition (e.g., over or equal to Low in FIG. 2).

The level determining unit 120 may determine a level 4 is reached in case where the level 3 conditions are satisfied fully or partly except for a predetermined condition and one of the following level 4 conditions or two or more according to a setting is satisfied [the excluded ones of the level 3 conditions may be a road type condition (e.g., general road or city road)]:

It is within a predetermined time after being set to be valet mode.

The travelled distance after being set to be valet mode is within a predetermined distance.

The vehicle location is recognized as a parking lot.

PAS is activated.

A door/hood/trunk/charging-door/fuel-door is open.

A plurality of people are on board (detected by seat sensors).

The seat belt for a seat sensed as being seated is not buckled.

The speed limit of the road is below or equal to a predetermined value (e.g., 30 kph), preferably the predetermined value being below or equal to the speed limit of the level 3 condition.

The SOC is over or equal to a predetermined value, preferably the predetermined value being over or equal to the SOC of the level 3 condition (e.g., Normal or higher in FIG. 2).

If the level determining unit 120 determines the level for the valet mode according to the determination of the above described conditions by level, the control unit 130 may perform a control of the vehicle correspondingly to the determined level.

For example, in case where the levels of the valet mode are divided in 4 steps as described above, a control of the vehicle at each level is as follows.

At first, the level 1 is the most basic level, which may be aimed to provide information on the vehicle and force an operation of a safety assistance apparatus.

In further detail, in level 1, the control unit 130 may calculate the operation time of the vehicle, the travelled distance, the average speed, the maximum speed, the average acceleration, the maximum acceleration, the maximum deceleration, the maximum APS value, the maximum BPS value, the engine turned-on times, the consumed amount of fuel, the amount of usage of the air-conditioner, the idling duration time, the ignition on/off times, the charging amount by outside power source, etc. while the valet mode being activated on, and transmit those to the user's terminal through such as a telematics center or make them to be displayed through a display equipped in the vehicle when the valet mode dismissed. Preferably, the engine turned-on times, the consumed amount of fuel, and the ignition on/off times are only applied to an eco-friendly vehicle having an engine (e.g. HEV, PHEV).

Also, the control unit 130, in level 1, may activate a safety assistance system/function such as Emergency Braking system, Blind Spot Detection (BSD) system, Lane Departure Warning system, etc., and automatically set at least one speed limit function to the speed corresponding to a speed limit obtained through the Navigation or a camera. Of course, the acceleration limit function can be set likewise.

Next, level 2 may include basically the controls of the level 1, and is aimed, further to the controls of the level 1, to restrict the use of convenience features and non-basic additional functions, enhance the safety assistance functions, and partially prevent unnecessary consumption of fuel. The added controls in the level 2 may include at least one of the following:

Prevention of use of Terrain/Spots-mode or the like.

Automatic setting of a speed limit function to the speed (e.g., 70 kph) corresponding to a speed limit obtained through the Navigation or a camera or below the speed limit of the level 1, and/or acceleration limit to below that of level 1.

Raising an EV Line (i.e., a threshold for switching to HEV mode, such as for example, a requested output corresponding to 110% of default EV Line.

Prevention of use of Cruise Control.

Prevention of use of Lane Keeping Assistance system

Prevention of a path-search function of Navigation, there may be an exception for a function for informing of a location of the valet mode being activated on and path-guiding thereto.

Restriction on control of media (e.g., prevention of use of Radio, Audio, and Bluetooth.

Prevention of the use of Auto Hold.

Setting of warning sound of various safety assistance functions (e.g., Forward Collision Prevention Assist, BSD, Lane Departure Warning) to the maximum volume.

Setting of various safety informing sounds of the Navigation to predetermined volume levels (levels high enough for a driver to recognize).

Allowing the output of the FATC (Full Automatic Temperature Control) up to a predetermined percentage of the full powered output based on the outside temperature or a comparison of an inside temperature and a temperature of weather information (e.g., 20% by default, 501 in case of a predetermined difference between outside and inside temperatures, 70% when defogging is necessary, etc.). Deciding whether to allow seat heating elements or fans according to outside temperature or a temperature of weather information.

Next, the level 3 may include basically the controls of the level 2, and is aimed, further to the controls of the level 2, to further prevent unnecessary consumption of fuel. The added controls in the level 3 may include at least one of the following:

Forcing use of Eco mode or the like.

Automatic setting of a speed limit function to the speed (e.g., 50 kph) corresponding to a speed limit obtained through the Navigation or a camera or below the speed limit of the level 2, and/or acceleration limit to below that of the level 2.

Further raising EV Line (e.g., requested output corresponding to 120% of the previous power threshold).

Next, the level 4 may include basically the controls of the level 3, and is aimed, further to the controls of the level 3, to prevent further unnecessary consumption of fuel and violent driving. The added controls. in the level 4 may include at least one of the following:

Automatic setting of a speed limit function to the speed (e.g., 30 kph) corresponding to a speed limit obtained through the Navigation, or a camera, or below the speed limit of the level 3, and/or an acceleration limit to below that of the level 3
Prevention of the engine being turned on according to a requested power.
Prevention of the engine being turned on according to a request of the FATC.
Prevention of the engine being turned on according to a request for catalyst heating.
Prevention of the engine being turned on according to a request for warm-up.

Enhancing a APS scaling.

Enhancing filtering of a requested torque.

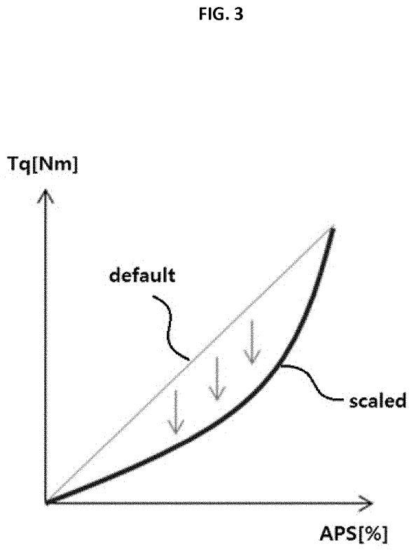

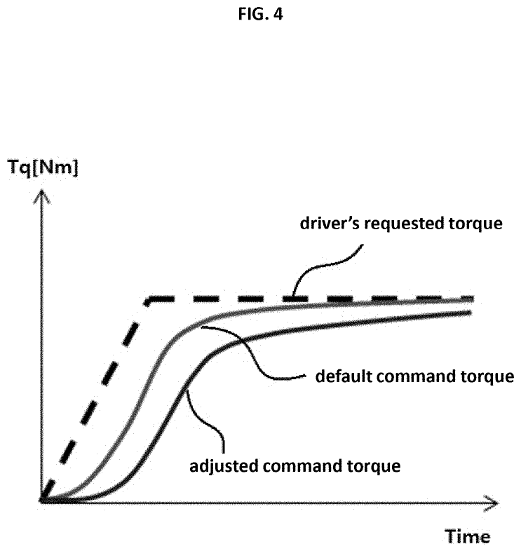

The enhancement of an APS scaling and the enhancement of filtering of a requested torque are detailed in reference to FIGS. 3 and 4.

FIG. 3 is an example of an APS scaled according to an embodiment of the present disclosure.

In reference to FIG. 3, the requested torque (Tq) is linear by default before an APS scaling applied, but may have, once the scaling is applied, a lower value compared to the one of the default case for the same APS value. If an APS scaling is basically applied for determining a requested torque, then, in the level 4, more enhanced APS scaling may be applied.

FIG. 4 is an example of a torque command being adjusted in accordance with a driver's requested torque according to an embodiment of the present disclosure.

In reference to FIG. 4, a control unit of a powertrain of a general eco-friendly vehicle, once a driver's requested torque is determined, determine a command torque (i.e., default command torque) after applying a filtering to the determined requested torque to reduce the fluctuation width thereof. In the level 4 control according to an embodiment, more enhanced filtering may be applied and an adjusted command torque for controlling further smoothly the fluctuation width of torque may be determined.

On the other hand, preferably, in the above described levels 2 to 4, the acceleration limit function is not applied to simply restrict the output power from the maximum power, but to restrict the acceleration with reference to the maximum acceleration able to be exerted by speed of the vehicle on a flat road (i.e., restrict with a restricting range varied according to a slop degree of road) Accordingly, the amount of the restriction of output power may become small or none in a situation difficult to accelerate like hill climbing, and the restriction of output power may occur additionally compared to running on a flat road in a situation easy to accelerate like hill descending.

TABLE 2 represents an example of a function control by level according to another embodiment.

TABLE 2

| Level | Lv. 1 | Lv. 2 | Lv. 3 | Lv. 4 |
|---|---|---|---|---|
| Engine | EV line 10% | EV line 20% | EV line 30% | Preventing the |
| | raising | raising | raising | engine from |
| | | | | being |
| | | | | turned on |
| | | | | according to a |
| | | | | request of |
| | | | | Requested- |
| | | | | power/FATC/ |
| | | | | catalyst- |
| | | | | heating/ |
| | | | | warm-up |
| FATC | Allowing the | Allowing the | Allowing the | Preventing the |
| | Power up to | Power up to | Power up to | air-conditioning |
| | 90% | 70% | 50% | |
| Speed | Setting to | Setting to | Setting to 50 | Setting to 30 |
| Limit | 110 kph by | 90 kph by | kph by force | kph by force |
| | force | force | (general | (parking lot) |
| | (expressway) | (national | road) | Positive |
| | | highway) | | Action Disable |
| Acceleration | Further | Acceleration | Acceleration | Acceleration |
| Limit | adjusting | limit Lv. 1 | limit Lv. 2 | limit Lv. 3 |
| | APS scaling, | | | |
| | enhancing | | | |
| | filtering for | | | |
| | requested | | | |
| | torque | | | |
| Impact in | Reducing R- | Reducing | Reducing R- | Reducing |
| Parking | gear creep | creep torque | gear | accelerating |
| | torque | with PAS | accelerating | torque |
| | | activated | torque | with PAS |
| | | | | activated |
| Drive | — | | | |
| Estimation | | | | |
| Parking | Informing to | Informing to | Preventing by | Preventing by |
| Location | parkat | park at | force from | force from |
| | places other | places other | parking at | parking |
| | than “No | than not- | “No Parking” | at not-preferred |
| | Parking” area | preferred | area | parking area |
| | | parking area | | |
| Mode | Preventing | Preventing | Forcing the | — |
| Restriction | the use of | the use of | use of Eco | |
| | Sports mode | Terrain mode | mode | |
| Safety | Activating | — | Setting the | — |
| Function | Emergency | | warning | |
| | Braking, | | sound to the | |
| | activating | | maximum | |
| | BSD, raising | | volume level | |
| | the volume | | | |
| | level of | | | |
| | warning | | | |
| | sound, | | | |
| | activating | | | |
| | Lane | | | |
| | Departure | | | |
| | Warning | | | |
| | System | | | |

The function control by level set forth above in the TABLE 2 is an example, without being limited thereto, and a person having ordinary skill in the art will recognize that the function control can vary in various forms.

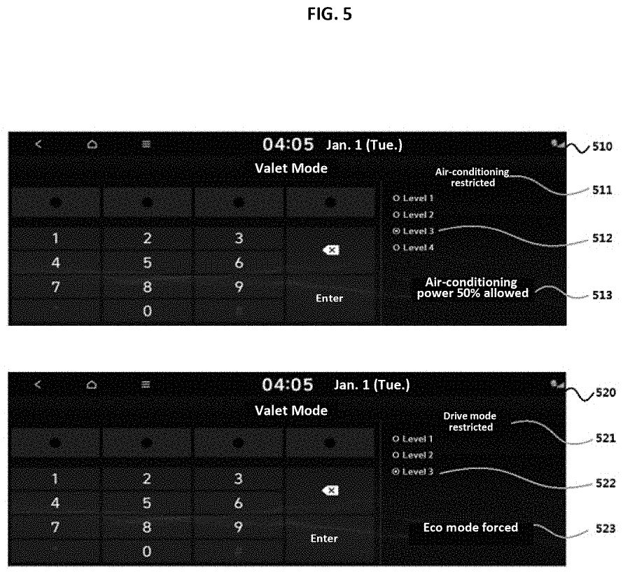

For example, a function control may not be dependent on a level, but the level may be set by the function control. This is detailed in reference to FIG. 5.

FIG. 5 is an example of a level being set by function according to an embodiment of the present disclosure.

In reference to FIG. 5, a USM for valet mode may be accessed by a user's input of commands through the AVN system.

For example, a user can access a level setting menu 510 for restricting the air-conditioning or a lever setting menu 520 for restricting the drive mode.

On each menu 510, 520, function 511, 521 to be set currently, set level 512, 522, description 513, 523 on the function according to the set level, etc. may be displayed.

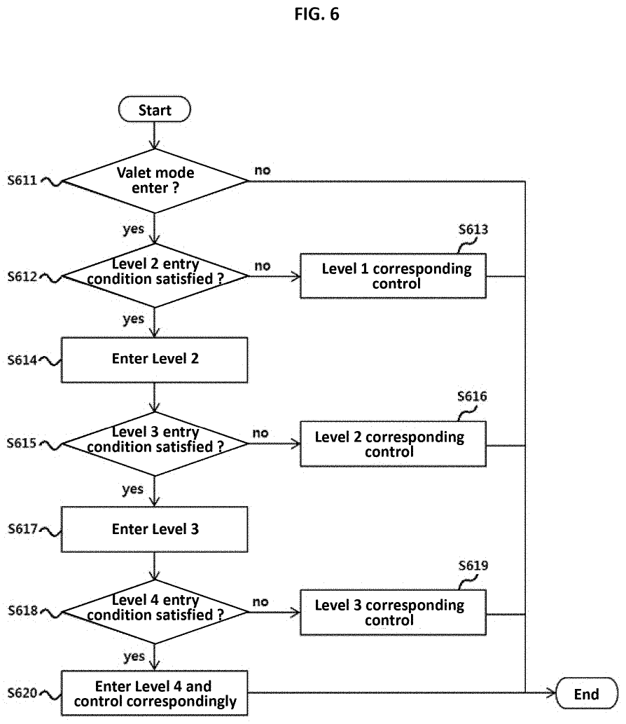

A flowchart for the procedure of valet mode described above is shown in FIG. 6.

FIG. 6 is a flowchart of an example of a procedure of a valet mode control according to an embodiment of the present disclosure.

In reference to FIG. 6, first, the entry determining unit 110 of the valet mode control unit 100 may determine whether an entry condition of the valet mode to be satisfied (S611).

If at least one of the entry conditions is determined to be satisfied in the entry determining unit 110, then the level determining unit 120 may determine whether an entry condition for the level 2 is satisfied (S612).

If the entry condition for the level 2 is not satisfied (No in S612), then the level determining unit 120 may determine the level 1, and accordingly the control unit 130 may perform a vehicle control corresponding to the level 1 (S613).

Otherwise, if the entry condition for the level 2 is satisfied (Yes in S612), then the level determining unit 120 may set temporarily the valet mode level to 2 (S614) and determine an entry condition for the level 3 (S615).

If the entry condition for the level 3 is not satisfied (No in S615), then the level determining unit 120 may determine to set the level to 2, and accordingly the control unit 130 may perform a vehicle control corresponding to the level 2 (S616).

Otherwise, if the entry condition for the level 3 is satisfied (Yes in S615), then the level determining unit 120 may set temporarily the valet mode level to 3 (S617) and determine an entry condition for the level 4 (S618).

If the entry condition for the level 4 is not satisfied (No in S618), then the level determining unit 120 may determine to set the level to 3, and accordingly the control unit 130 may perform a vehicle control corresponding to the level 3 (S619).

Otherwise, if the entry condition for the level 4 is satisfied (Yes in S618), then the level determining unit 120 may determine the valet mode level to be 4 and the control unit 130 may perform a vehicle control corresponding to the level 4 (S620).

In the above described embodiments, the way of leveling like 1 to 4 is only an example, and since it means that a way and a type of control may vary according to a variation of the level, it is obvious to a person having ordinary skill in the art that other expressions such as A, B, C, D or 4, 3, 2, 1 keeping the same meaning are possible.

Further, among the levels described above, two or more may be integrated into one, and any level may be divided a plurality of lower levels according to a condition. In addition, corresponding controls may be performed with individual levels set by parameter (e.g., speed limit, SOC, etc.) of a vehicle state.

What is claimed is:

1. A method for controlling a valet mode of a vehicle comprising:
determining whether an entry condition for the valet mode is satisfied;
determining, if the condition is satisfied, one level among a plurality of levels for the valet mode based on at least one of a vehicle state and a driving environment; and
performing a vehicle control according to the determined level,
wherein the plurality of levels are different from one another in whether or not a restriction to be made to at least part of a powertrain and a vehicle function or a degree of the restriction.

2. The method of claim 1, wherein the determination of one level is made by determining entry conditions of the respective levels sequentially from a lowest level.

3. The method of claim 2, wherein the entry conditions of the respective levels are made up such that entry conditions of each level include at least a part of entry conditions of a lower level.

4. The method of claim 2, wherein, if the vehicle is an eco-friendly vehicle having an electric motor, the higher the level is, the higher a condition of SOC for a battery as the entry condition thereof is.

5. The method of claim 4, wherein, in a case in which the vehicle further comprises an engine, the performing of the vehicle control comprises raising a threshold power for turning the engine on at an upper level.

6. The method of claim 5, wherein the performing of the vehicle control is conducted such that a start of the engine according to at least one of a requested power, a request of FATC, a request of catalyst heating, a request of warm-up is prevented.

7. The method of claim 1, wherein the performing of the vehicle control is conducted such that the higher the determined level is, the lower a speed limit or an acceleration limit is set automatically.

8. The method of claim 6, wherein a restricting range for the acceleration limit is set with a slope degree taken into consideration with reference to a maximum acceleration by speed able to be achieved by the vehicle on a flat road.

9. The method of claim 1, wherein the entry conditions of the respective levels comprise at least one of a road type, a speed limit, whether or not to be an emergency, a SOC of a battery, a travelled time and a travelled distance after an entry of the valet mode, and whether or not a specific function to be activated on.

10. A computer-readable storage medium storing a program for implementing the method of claim 1.

11. An apparatus for controlling a valet mode of a vehicle comprising:
an entry determining unit configured to determine whether an entry condition for the valet mode is satisfied;
a level determining unit configured to determine, in an event that the condition is satisfied, one level among a plurality of levels for the valet mode based on at least one of a vehicle state and a driving environment; and
a control unit configured to perform a vehicle control according to the determined level,
wherein the plurality of levels are different from one another in whether or not a restriction to be made to at least part of a powertrain and a vehicle function or a degree of the restriction.

12. The apparatus of claim 11, wherein the level determining unit determines a plurality of entry conditions of the respective levels sequentially from a lowest level.

13. The apparatus of claim 12, wherein the plurality of entry conditions of the respective levels are made up such that entry conditions of each level include at least a part of entry conditions of a lower level.

14. The apparatus of claim 12, wherein, when the vehicle is an eco-friendly vehicle having an electric motor, the higher the level is, the higher a condition for SOC of a battery as the entry condition thereof is.

15. The apparatus of claim 14, wherein, when the vehicle further comprises an engine, the control unit raises a threshold power for turning the engine on at an upper level.

16. The apparatus of claim 15, wherein the control unit prevents the engine from being started according to at least one of a requested power, a request of FATC, a request of catalyst heating, a request of warm-up.

17. The apparatus of claim 11, wherein the higher the determined level, the more the control unit reduces a speed limit or an acceleration limit.

18. The apparatus of claim 17, wherein a restricting range for the acceleration limit is set with a slope degree taken into consideration with reference to a maximum acceleration by speed able to be achieved by the vehicle on a flat road.

19. The apparatus of claim 12, wherein the entry conditions of the respective levels comprise at least one of a road type, a speed limit, whether or not to be an emergency, a SOC of a battery, a travelled time and a travelled distance after an entry of the valet mode, and whether or not a specific function to be activated on.
